(19) United States
(12) Patent Application Publication
(10) Pub. No.: US 2025/0310031 A1
(43) Pub. Date: Oct. 2, 2025

(54) SIGNALING OF APPLICATION-LAYER FORWARD ERROR CORRECTION (FEC) INFORMATION FOR PROTOCOL DATA UNIT (PDU) SETS

(71) Applicant: QUALCOMM Incorporated, San Diego, CA (US)

(72) Inventors: Liangping Ma, San Diego, CA (US); Hyun Yong Lee, San Diego, CA (US); Prashanth Haridas Hande, San Diego, CA (US); Imed Bouazizi, Celina, TX (US); Thomas Stockhammer, Bergen (DE); Sebastian Speicher, Wallisellen (CH); Prasada Veera Reddy Kadiri, San Diego, CA (US)

(21) Appl. No.: 19/089,750

(22) Filed: Mar. 25, 2025

Related U.S. Application Data
(60) Provisional application No. 63/572,798, filed on Apr. 1, 2024.

(51) Int. Cl. H04L 1/00; H04L 1/1607; H04L 65/65

(52) U.S. Cl. CPC H04L 1/0061; H04L 1/1642; H04L 65/65

(57) ABSTRACT

A device configured to transmit data may generate one or more source protocol data units (PDUs) in a PDU set, and generate one or more corresponding repair PDUs in the PDU set, wherein the source PDUs and the repair PDUs share the same PDU set sequence number (PSSN), and wherein the corresponding repair PDUs are used for forward error correction (FEC), and transmit the PDU set. A real-time transport protocol header extension (HE) may include information that indicates whether a PDU in the PDU set is a source PDU or a repair PDU.

This application claims the benefit of U.S. Provisional Patent Application No. 63/572,798, filed Apr. 1, 2024, the entire content of which is incorporated by reference herein.

### TECHNICAL FIELD

This disclosure relates to the transport of data and forward error correction techniques.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques related to communicating (e.g., sending, receiving, or forwarding) data. The data may include media data, video data, extended reality (XR) media data, which may include any or all of text data, audio data, video data, mixed reality (MR) data, augmented reality (AR) data, and/or virtual reality (VR) data. Data may be partitioned and encapsulated in protocol data units (PDUs), which may be communicated in bursts of activity on radio signals. Likewise, PDUs may be organized into PDU Sets, which may include a set of PDUs to be consumed together by a receiver. For example, a PDU Set may include respective PDUs including audio, video, and XR data. Furthermore, PDU Sets and ends of bursts (EoBs) may be marked to help identify XR traffic and optimize its delivery.

This disclosure describes techniques for signaling application-layer forward error correction (FEC) information for PDU sets. In particular, this disclosure describes techniques for binding source packets and repair (e.g., parity) packets in the case of systematic FEC, as well as techniques for exposing FEC information more efficiently.

In one example, this disclosure describes a method of transmitting data, the method comprising generating one or more source protocol data units (PDUs) in a PDU set, generating one or more corresponding repair PDUs in the PDU set, wherein the source PDUs and the repair PDUs share the same PDU set sequence number (PSSN), and wherein the corresponding repair PDUs are used for forward error correction (FEC), and transmitting the PDU set.

In another example, this disclosure describes an apparatus configured to transmit data, the apparatus comprising a memory, and processing circuitry connected to the memory, the processing circuitry configured to generate one or more source protocol data units (PDUs) in a PDU set, generate one or more corresponding repair PDUs in the PDU set, wherein the source PDUs and the repair PDUs share the same PDU set sequence number (PSSN), and wherein the corresponding repair PDUs are used for forward error correction (FEC), and transmit the PDU set.

In another example, this disclosure describes a method of receiving data, the method comprising receiving one or more source protocol data units (PDUs) in a PDU set, and receiving one or more corresponding repair PDUs in the PDU set, wherein the source PDUs and the repair PDUs share the same PDU set sequence number (PSSN), and wherein the corresponding repair PDUs are used for forward error correction (FEC).

In another example, this disclosure describes an apparatus configured to receive data, the apparatus comprising a memory, and processing circuitry connected to the memory, the processing circuitry configured to receive one or more source protocol data units (PDUs) in a PDU set, and receive one or more corresponding repair PDUs in the PDU set, wherein the source PDUs and the repair PDUs share the same PDU set sequence number (PSSN), and wherein the corresponding repair PDUs are used for forward error correction (FEC).

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an architecture for a system that may be configured to perform immersive real-time communication for Web Real-Time Communication (WebRTC) according to techniques of this disclosure.

FIG. 2 shows an example RTP packet format.

FIG. 3 shows another example RTP packet format.

FIG. 4 shows an example packet format for Reed-Solomon FEC.

FIG. 5 shows an example FEC repair packet.

FIG. 6 is a block diagram illustrating elements of an example video file.

FIG. 7 shows an example bitmask according to the techniques of this disclosure.

FIG. 8 shows one example of real-time transport protocol (RTP) header extensions according to the techniques of this disclosure.

FIG. 9 shows another example of RTP header extensions according to the techniques of this disclosure.

FIG. 10 shows another example of RTP header extensions according to the techniques of this disclosure.

FIG. 11 shows an example of packet generation for application layer FEC according to the techniques of this disclosure.

FIG. 12 shows an example process perform by a source device according to the techniques of this disclosure.

FIG. 13 shows an example process perform by client device according to the techniques of this disclosure.

### DETAILED DESCRIPTION

In general, this disclosure describes techniques related to communicating media data, such as video data, and/or extended reality (XR) media data. XR media data may include any or all of text data, voice data, audio data, still image data, video data, mixed reality (MR) data, augmented reality (AR) data, and/or virtual reality (VR) data. The marking of XR traffic is a mechanism that helps the network to identify XR traffic and optimize its delivery. The concept of protocol data unit (PDU) sets has been introduced specifically for this purpose, but can also be used for other types of traffic. PDU sets are PDUs that are consumed together by the receiver, and as such should be handled together by the network.

This disclosure describes techniques for signaling application-layer forward error correction (FEC) information for PDU sets. In particular, this disclosure describes techniques for binding source packets and repair (e.g., parity) packets in the case of systematic FEC, as well as techniques for exposing FEC information more efficiently. In this context, binding source packets and repair packets means providing information that indicates which repair packets correspond to particular source packets. Such repair packets may be used for FEC techniques to correct errors with the corresponding source packets.

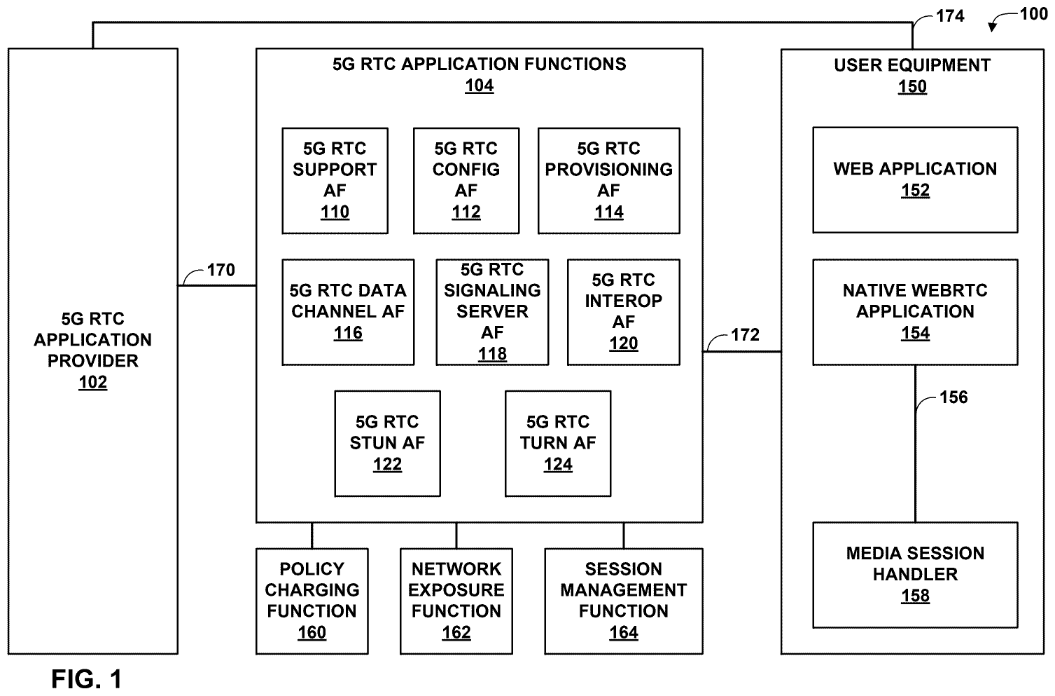

FIG. 1 is a block diagram illustrating an architecture 100 for a system that may be configured to perform the FEC signaling techniques for PDU sets of this disclosure. In some examples, architecture 100 may be used for 5G media streaming (5GMS) using Web Real-time Communication (WebRTC) or 5G real-time transport protocol (5G RTP). That is, architecture 100 may be used to perform WebRTC and/or RTP real time communication over a 5G network connection.

Architecture 100 may be used to provide WebRTC in a variety of scenarios. As one example, architecture 100 may be used in conjunction with a 5G network to provide “over the top” (OTT) WebRTC. As another example, a mobile network operator (MNO) may provide trusted WebRTC functions and/or facility WebRTC services using architecture 100. As still another example, architecture 100 may provide inter-operable WebRTC services. Architecture 100 may also be used for various other scenarios as well. Architecture 100 provides flexibility through a set of functions and interfaces that can be combined in different ways based on the needs for a particular scenario.

In the example of FIG. 1, architecture 100 includes 5G RTC application provider 102, 5G RTC application functions 104, and user equipment (UE) 150. In general, 5G RTC application provider 102 interacts with functions of 5G RTC application functions 104 and supplies a 5G RTC-aware application, such as web application 152, to user equipment 150.

User equipment 150 may also be referred to as “UE” or a “client device.” User equipment 150 may be, for example, a laptop or desktop computer, a digital camera, a digital recording device, a digital media player, a video gaming device, a video game console, a cellular or satellite radio telephone, a video teleconferencing device, or the like. In this example, user equipment 150 includes web application 152, native WebRTC application 154, and media session handler (MSH) 158. Interface 156 couples native WebRTC application 154 and MSH 158. Interface 156 may be referred to as an “RTC-6” interface. UE 150 and 5G RTC application provider 102 are coupled by interface 174, which may be referred to as an “RTC-8” interface.

MSH 158 is a function in UE 150 that provides WebRTC applications, such as web application 152, access to 5G RTC support functions, such as 5G RTC application functions 104. These functions may be offered on request through the interface 156 (the RTC-6 interface) or transparently without direct involvement of web application 154. MSH 158 may, for instance, assist indirectly in interactive connectivity establishment (ICE) negotiation by providing a list of Session Traversal Utilities for Network Address Translation (STUN) and/or Traversal Using Relay around NAT (TURN) server candidates that offer 5G RTC functionality. MSH 158 may also collect quality of experience (QoE) metric reports and submit consumption reports. MSH 158 may also offer media configuration recommendations to web application 152 through interface 156 (RTC-6).

Interface 170 (which may be referred to as an “RTC-1” interface) allows 5G RTC application provider 102 to provision support for offered RTC sessions as 5G RTC application functions 104. The provisioning may cover functionalities including quality of service (QOS) for WebRTC sessions, charging provisioning for WebRTC sessions, collection of consumption and QoE metrics data related to WebRTC sessions, offering ICE functionality, such as STUN and TURN servers, and/or offering WebRTC signaling servers, potentially with interoperability to other signaling servers.

In this example, 5G RTC application functions 104 include 5G RTC support application function (AF) 110, 5G RTC configuration (config) AF 112, 5G RTC provisioning AF 114, 5G RTC data channel AF 116, 5G RTC signaling server AF 118, 5G RTC interoperability (interop) AF 120, 5G RTC STUN AF 122, and 5G RTC TURN AF 124. In this example, 5G RTC application functions 104 are also interoperable with policy and charging function (PCF) 160, network exposure function (NEF) 162, and session management function (SMF) 164.

Interface 170, which may be referred to as a “provisioning interface,” is not necessarily relevant to all collaboration scenarios, and some of the 5G support functionality may be offered without application provider provisioning.

Interface 172 (which may be referred to as an “RTC-5” interface) is an interface between MSH 158 and 5G RTC application functions 104. Interface 172 may be used to convey configuration information from 5G RTC application functions 104 to MSH 158 and to request support for a starting/ongoing WebRTC session. The configuration information may include static information such as recommendations for media configurations, configurations of STUN and TURN server locations, configuration about consumption and QoE reporting, or discovery information for WebRTC signaling and data channel servers and their capabilities.

MSH 158 may provide support functionality such as informing 5G RTC application functions 104 or web application 152 about a WebRTC session and its state, requesting QoS allocation for a starting or modified WebRTC session, receiving a notification about changes to the QoS allocation for an ongoing WebRTC session, or receiving, updating, or exchanging information about the WebRTC session with the 5G RTC STUN/TURN/Signaling Server, e.g., to identify a WebRTC session and associate it with a QoS template.

In some examples, the 5G functionality that offer application functions to the WebRTC application (including 5G RTC data channel AF 116, 5G RTC signaling server AF 118, 5G RTC interop AF 120, 5G RTC STUN AF 122, and 5G RTC TURN AF 124) may instead be provided by Application Servers (5G RTC AS) instead of AFs. The 5G RTC AS could then use a dedicated RTC-3 interface to request configurations and network support for the ongoing WebRTC sessions from the 5G RTC AF.

Functionality attributed to 5G RTC application provider 102, 5G RTC application functions 104, and UE 150 may be implemented in hardware, software, firmware, or any combination thereof. When implemented in software or firmware, memory may be provided for storing instructions that may be executed by one or more processors implemented in circuitry. Processors may include one or more of microprocessors, digital signal processors (DSPs), application specific integrated circuits (ASICs), field programmable gate arrays (FPGAs), discrete logic circuitry, or any combinations thereof.

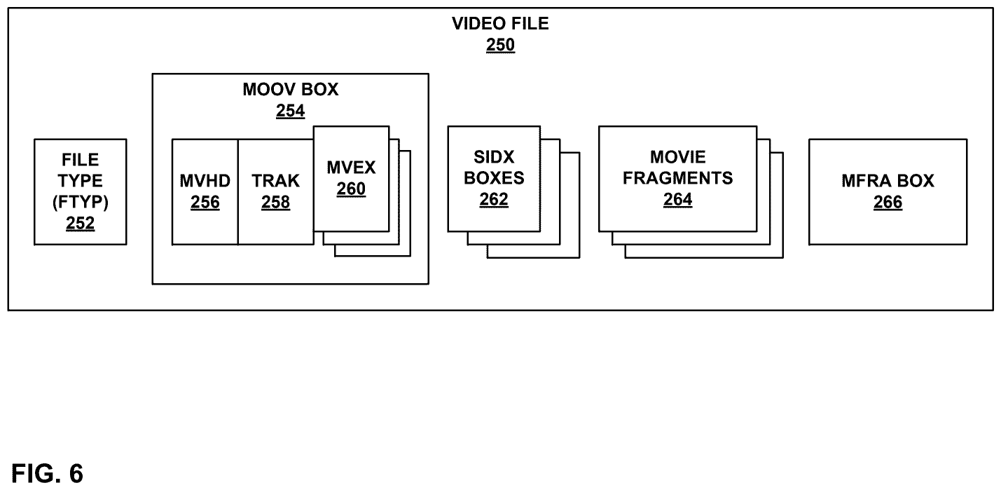

FIG. 6 is a block diagram illustrating elements of an example video file 250. Video files in accordance with the ISO base media file format and extensions thereof store data in a series of objects, referred to as “boxes.” In the example of FIG. 6, video file 250 includes file type (FTYP) box 252, movie (MOOV) box 254, segment index (sidx) boxes 262, movie fragment (MOOF) boxes 264, and movie fragment random access (MFRA) box 266. Although FIG. 6 represents an example of a video file, it should be understood that other media files may include other types of media data (e.g., audio data, timed text data, or the like) that is structured similarly to the data of video file 250, in accordance with the ISO base media file format and its extensions.

File type (FTYP) box 252 generally describes a file type for video file 250. File type box 252 may include data that identifies a specification that describes a best use for video file 250. File type box 252 may alternatively be placed before MOOV box 254, movie fragment boxes 264, and/or MFRA box 266.

MOOV box 254, in the example of FIG. 6, includes movie header (MVHD) box 256, track (TRAK) box 258, and one or more movie extends (MVEX) boxes 260. In general, MVHD box 256 may describe general characteristics of video file 250. For example, MVHD box 256 may include data that describes when video file 250 was originally created, when video file 250 was last modified, a timescale for video file 250, a duration of playback for video file 250, or other data that generally describes video file 250.

TRAK box 258 may include data for a track of video file 250. TRAK box 258 may include a track header (TKHD) box that describes characteristics of the track corresponding to TRAK box 258. In some examples, TRAK box 258 may include coded video pictures, while in other examples, the coded video pictures of the track may be included in movie fragments 264, which may be referenced by data of TRAK box 258 and/or sidx boxes 262.

In some examples, video file 250 may include more than one track. Accordingly, MOOV box 254 may include a number of TRAK boxes equal to the number of tracks in video file 250. TRAK box 258 may describe characteristics of a corresponding track of video file 250. For example, TRAK box 258 may describe temporal and/or spatial information for the corresponding track. A TRAK box similar to TRAK box 258 of MOOV box 254 may describe characteristics of a parameter set track, when encapsulation unit 30 (FIG. 1) includes a parameter set track in a video file, such as video file 250. Encapsulation unit 30 may signal the presence of sequence level SEI messages in the parameter set track within the TRAK box describing the parameter set track.

MVEX boxes 260 may describe characteristics of corresponding movie fragments 264, e.g., to signal that video file 250 includes movie fragments 264, in addition to video data included within MOOV box 254, if any. In the context of streaming video data, coded video pictures may be included in movie fragments 264 rather than in MOOV box 254. Accordingly, all coded video samples may be included in movie fragments 264, rather than in MOOV box 254.

MOOV box 254 may include a number of MVEX boxes 260 equal to the number of movie fragments 264 in video file 250. Each of MVEX boxes 260 may describe characteristics of a corresponding one of movie fragments 264. For example, each MVEX box may include a movie extends header box (MEHD) box that describes a temporal duration for the corresponding one of movie fragments 264.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 264. Encapsulation unit 30 may further signal the presence of a sequence data set and/or sequence level SEI messages as being present in one of movie fragments 264 within the one of MVEX boxes 260 corresponding to the one of movie fragments 264.

SIDX boxes 262 are optional elements of video file 250. That is, video files conforming to the 3GPP file format, or other such file formats, do not necessarily include SIDX boxes 262. In accordance with the example of the 3GPP file format, a SIDX box may be used to identify a sub-segment of a segment (e.g., a segment contained within video file 250). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub) segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 262 generally provide information representative of one or more sub-segments of a segment included in video file 250. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 264 may include one or more coded video pictures. In some examples, movie fragments 264 may include one or more groups of pictures (GOPs), each of which may include a number of coded video pictures, e.g., frames or pictures. In addition, as described above, movie fragments 264 may include sequence data sets in some examples. Each of movie fragments 264 may include a movie fragment header box (MFHD, not shown in FIG. 6). The MFHD box may describe characteristics of the corresponding movie fragment, such as a sequence number for the movie fragment. Movie fragments 264 may be included in order of sequence number in video file 250.

MFRA box 266 may describe random access points within movie fragments 264 of video file 250. This may assist with performing trick modes, such as performing seeks to particular temporal locations (i.e., playback times) within a segment encapsulated by video file 250. MFRA box 266 is generally optional and need not be included in video files, in some examples. Likewise, a client device, such as client device 40, does not necessarily need to reference MFRA box 266 to correctly decode and display video data of video file 250. MFRA box 266 may include a number of track fragment random access (TFRA) boxes (not shown) equal to the number of tracks of video file 250, or in some examples, equal to the number of media tracks (e.g., non-hint tracks) of video file 250.

In some examples, movie fragments 264 may include one or more stream access points (SAPs), such as IDR pictures. Likewise, MFRA box 266 may provide indications of locations within video file 250 of the SAPs. Accordingly, a temporal sub-sequence of video file 250 may be formed from SAPs of video file 250. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

Application provider 102 and/or user equipment 150 may be configured to process PDUs and/or PDU sets using forward error correction (FEC) information. Application-layer FEC is in the scope of the 5G real-time transport protocol (RTP) phase 2 study item in 3GPP SA4 (Multimedia Codecs, Systems and Services). 5G RTP may facilitate low-latency, high-quality transmission of real-time data such as voice, video, alternative reality (AR), virtual reality (VR) and other time-sensitive applications.

A PDU a structured unit of data that is transmitted across the network. As one example, in 5G, a PDU session is an end-to-end connection established between UE 150 and 5G RTC application provider 102 (see FIG. 1), allowing the exchange of different types of data, including IP packets, Ethernet frames, or unstructured data. When RTP traffic is transmitted over 5G, it is encapsulated within a PDU session to ensure efficient and reliable real-time data delivery.

An RTP PDU may include an RTP header and payload, which are encapsulated within a UDP/IP packet and transported over the 5G network. A 5G Quality of Service (QoS) framework may map the RTP packets to specific QoS flows, better ensuring low latency, minimal jitter, and prioritized delivery for real-time applications such as Voice over New Radio (VoNR) and video conferencing. When RTP data is transmitted within a 5G network, the RTP PDU is encapsulated within different network layers to facilitate delivery. For example, an RTP PDU may be carried using GPRS Tunneling Protocol-User Plane (GTP-U) for transport across the 5G Core and is managed by the Service Data Adaptation Protocol (SDAP) at the Radio Access Network (RAN) level to ensure QoS compliance. A PDU set refers to a collection of PDUs that are transmitted together within a PDU session to support real-time media delivery.

In the context of FIG. 6, a PDU set would include data for one of movie fragments 264. Each of movie fragments 264 generally corresponds to a picture or set of slices. A PDU set may include the PDUs that encapsulate all or a portion of that picture.

Application layer FEC schemes may be used with data transmitted using PDUs and PDU sets. FEC is a technique used to enhance reliability in real-time media transmission by adding redundant data to RTP packets. This redundancy allows the receiver to detect and correct packet loss or corruption without needing retransmission. There are many application-layer FEC schemes with different RTP packet formats, including non-MDS (maximum distance separable) codes, near-MDS codes, and MDS codes.

MDS FEC codes are a class of forward error correction codes that achieve the theoretical limit of error correction and detection efficiency. MDS codes can recover the original data from the minimum number of received symbols required, meaning MDS codes offer optimal redundancy without wasting additional resources.

Non-MDS FEC codes, on the other hand, do not achieve this optimal redundancy and may require more redundant symbols to achieve the same level of error correction. Non-MDS codes often trade efficiency for other advantages, such as reduced computational complexity, lower latency, or improved adaptability to specific network conditions. While Non-MDS codes may not be as efficient in terms of the minimum required redundancy, they can still be highly effective in practical scenarios where computational constraints or varying error patterns must be considered.

Near-MDS FEC codes fall between MDS and non-MDS codes, providing error correction close to the optimal efficiency of MDS codes but with slight compromises. Near-MDS codes aim to balance redundancy, computational overhead, and performance, making them suitable for scenarios where strict MDS-level efficiency is not necessary but a more efficient approach than standard non-MDS codes is desirable.

Example non-MDS codes include FlexFEC (RFC 8627) and ULPFEC (RFC 5109), where ULPFEC stands for uneven level protection (ULP) FEC. Example MDS codes and near-MDS codes include RS (Reed-Solomon) FEC (RFC 5510, RFC 6865), Raptor (RFC 5053), and RaptorQ (RFC 6330).

The above FEC techniques are all systematic codes. A systematic code is an error-correcting code in which the input data is embedded in the encoded output. Some implementations (e.g., WebRTC) may deviate from the standards (e.g., IETF RFCs), for example, on the session and stream configuration. That is different FEC schemes used different FEC formats. In particular, some of the FEC schemes described above may use different information and schemes to indicate what repair packets are related to what source packets.

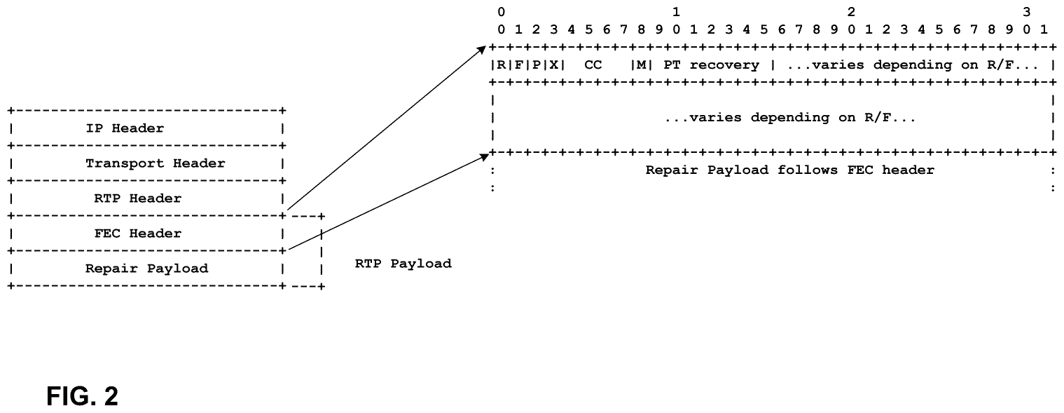

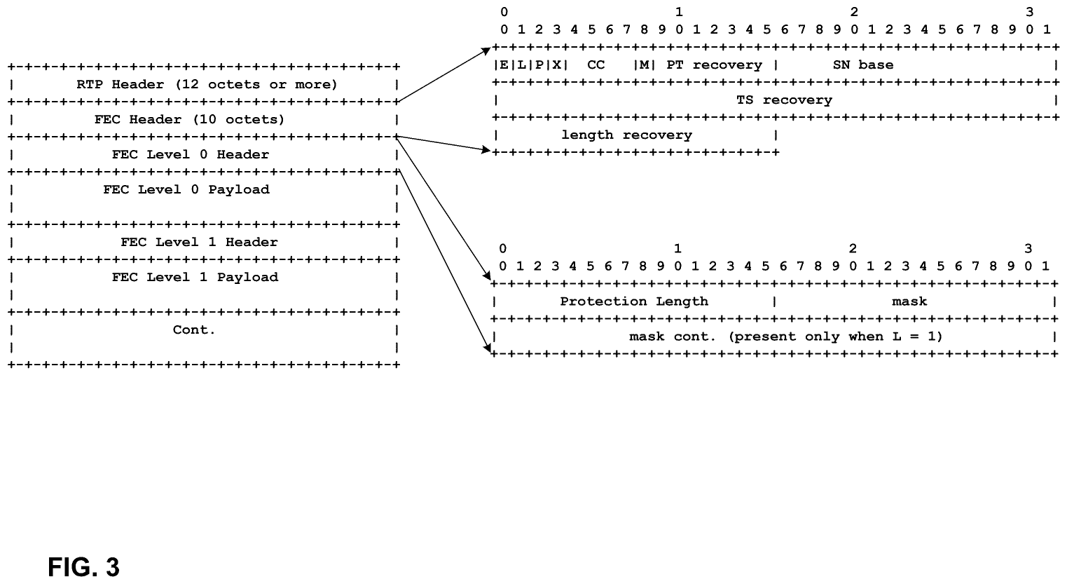

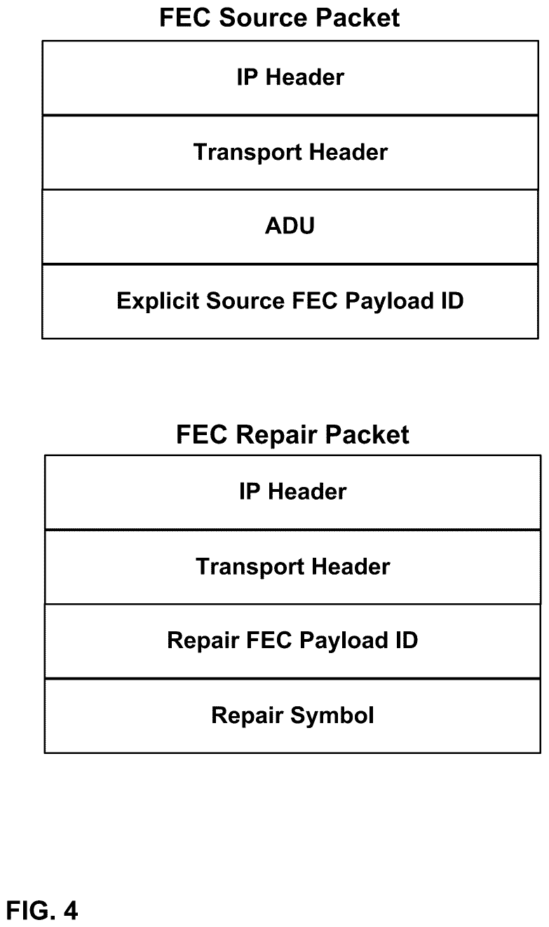

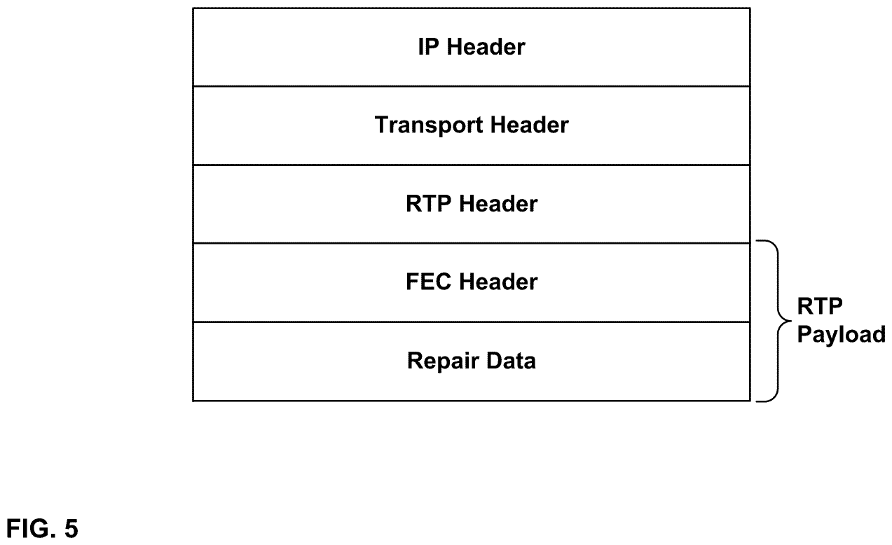

For examples, FIG. 2 shows an RTP Packet Format for FlexFEC (RFC 8267). The source packet is the same as regular RTP packets. FIG. 2 shows the format for repair packets. FIG. 3 shows an RTP packet format for ULPFEC (RFC 5109). The protection ratios are different for different FEC levels. FIG. 4 shows the packet format for RS FEC (RFC 6865). The explicit Source FEC Payload ID is composed of the Source Block Number, the Encoding Symbol ID of the source symbol contained in the source packet, and the Source Block Length. The Repair FEC Payload ID is composed of the Source Block Number (which links the repair packet to the source packet), the Encoding Symbol ID of the repair symbol in the repair packet, and the Source Block Length. FIG. 5 shows an example FEC repair packet.

In the context of FEC, a source packet is an original data packet that carries the primary information intended for transmission. These packets contain the actual payload, such as voice or video data in 5G RTP, before any error correction is applied. If all source packets are received correctly, no additional processing is needed for data reconstruction. A repair packet is a redundant packet generated using an FEC algorithm to help recover lost or corrupted source packets. Repair packets do not carry new information but instead contain encoded data derived from multiple source packets. If some source packets are lost during transmission, the receiver can use the repair packets to reconstruct the missing data without requiring retransmission, which is particularly useful in real-time applications where latency must be minimized.

In other FEC examples, information that binds a repair packet to a source packet for systematic FEC may be stored in the RTP payload in the source packet. However, when encryption is applied to the RTP payload, any information that indicates the binding of source packets and repair packets becomes invisible to network routing entities, such as base stations.

In view of the potential problems with systematic FEC handling, this disclosure describes techniques for binding source packets and repair packets. Sometimes repair packets are called parity packets. In the context of this disclosure, binding source packets and repair packets means providing information that indicates which repair packets correspond to particular source packets. Such repair packets may be used for FEC techniques to correct errors with the corresponding source packets. This disclosure also describes techniques for exposing FEC information more efficiently. The techniques of this disclosure make binding information between source packets and repair packets more accessible to network entities, thus facilitating better cross layer optimization.

### Example 1: Binding of the Source PDUs and Repair PDUs for Systematic FEC

Option 1: The source PDUs of an application data unit (e.g., a video frame) and the corresponding repair PDUs share the same PDU set sequence number (PSSN). A PSSN may be signaled in an RTP header extension (HE). A PSSN is a sequencing identifier used to maintain the correct order of PDU sets. Un Option 1, the source PDUs and the corresponding repair PDUs with the same PSSN as the source PDUs together form one PDU set. A network entity may determine which repair PDUs correspond to the source PDUs by matching the PSSN of the repair PDUs to the PDSSN of the source PDUS.

The techniques of Option 1 may be used for the case where the source PDUs and the repair PDUs are multiplexed in the same flow (e.g., the same RTP session, or the same IP 5-tuple). An IP 5-tuple is a set of five parameters used to uniquely identify a network flow in IP-based communication. The IP 5-tuple includes the source IP address, destination IP address, source port, destination port, and transport protocol. This combination allows network devices to track and manage individual data flows, enabling functions like routing, firewall filtering, and QoS enforcement. In the context of 5G RTP, the 5-tuple may be used to identify and prioritize real-time media streams, ensuring more efficient packet handling and minimal latency. The techniques of Option 1 may also be used for the case where the source PDUs and the repair PDUs are in different streams (e.g., identified by different RTP synchronization sources (SSRCs)) within the same flow.

Accordingly, in one example of the disclosure, a device (e.g., a UE, a base station (e.g., a gNB), and/or application provider) may be configured to transmit source PDUs and corresponding repair PDUs in one PDU set. In this example, the source PDUs and the repair PDUs share the same PSSN.

Option 2: In this example, the source PDUs alone form a first PDU set (e.g., called a source PDU Set). The corresponding repair PDUs alone to the source PDUs form a second PDU set (e.g., called repair PDU Set). The RTP HE of the PDUs of the repair PDU set carry the information that identifies the source PDU set. This technique may be used for both the case where the source PDUs and the repair PDUs are multiplexed in the same flow or in the case where the source PDUs and the repair PDUs are sent in different flows.

The RTP payload format for the PDUs carrying the source PDU Set may be the same as that without FEC. This allows for backward compatibility so that a receiver that does not support FEC can still successfully process the source PDU set (e.g., in multicast scenarios where some receivers support FEC and other receivers do not).

Additional details about the information that identifies the source PDU Set are described below:

1) If both the source PDU set and the repair PDU set are in the same flow, the information in the RTP HE of the repair PDU set includes the PSSN of the source PDU set.

2) Otherwise, if the source PDU set and the repair PDU set are in different flows (e.g., using ULPFEC according to RFC 5109), the information in the RTP HE of the repair PDU set includes a PSSN of the source PDU set and an identifier of the flow to which the source PDU set belongs.

Accordingly, the device (e.g., a UE, a base station (e.g., a gNB), and/or application provider) may be configured to transmit source PDUs in a first PDU set and transmit corresponding repair PDUs in a second PDU set. The device may further include information in an RTP header extension in the second PDU set that identifies the corresponding source PDUs in the first PDU set.

### Example 2: Indicating Other FEC Information in RTP Header Extension (HE)

In this example of the disclosure, application provider 102 and/or user equipment 150 may be configured to identify the packet type (e.g., source PDU vs repair PDU) in the RTP HE. The techniques of Example 2 may be used together with the techniques of Example 1.

Option 1: Application provider 102 and/or user equipment 150 may use two RTP header extension IDs, one RTP header extension ID for source PDUs (e.g., source RTP packets), and another RTP header extension ID for repair PDUs (e.g., repair RTP packets). This example may be used together with option 1 of Example 1 to identify the actual type of PDU (e.g., source or repair) when both the source PDUs and repair PDUs share the same PSSN. As described above, repair PDUs may be associated (e.g., bound) to source PDUs by having the source PDUs and the repair PDUs share the same PSSN. Option 1 of Example 2 may be used to provide an RTP header extension ID to explicitly indicate if a PDU is a source PDU or a repair PDU.

Option 2: Application provider 102 and/or user equipment 150 may use the same RTP header extension ID for source PDUs and repair PDUs, and differentiate the type of PDU with other information. In one example, source PDUs and repair PDUs may be differentiated with different subsets of the PSN space (e.g., even numbers are for source packets, and odd numbers are for repair packets, or vice versa). PSN stands for the PDU sequence number (SN) of a PDU within a PDU Set. In another example, source PDUs and repair PDUs may be differentiated with different PDU set importance (PSI) values. In another example, source PDUs and repair PDUs may be differentiated using a new field added to the RTP HE. As one example, the new field added to the RTP HE may be a field for PDU set marking. As still another example, source PDUs and repair PDUs may be differentiated using a reserved field in the RTP Header Extension.

Option 3: Application provider 102 and/or user equipment 150 may use an RTP header extension (which is part of the RTP header) to convey information about the FEC applied to the RTP payload, while not using any RTP header extension to indicate that an RTP packet is a source PDU. In this case the RTP header can be used to differentiate the two types of packets.

Further in Example 2, application provider 102 and/or user equipment 150 may be configured to add at least one or more of the following to the RTP header extension:
A field to indicate the redundancy level, e.g., the number of source PDUs, the number of repair PDUs, FEC coding rate, and/or redundancy ratio. For example, the redundancy ration may indicate a ratio of repair packets to source packets.
A field to indicate whether the RTP payload is encrypted or not, and if not encrypted, what FEC scheme is used. This field will allow a router, such as a user plane function (UPF) or base station, to inspect the RTP payload for more detailed information about the FEC scheme according to standards or known implementations. In another example, RTP endpoints inform the network (e.g., UE to AF (Application Function) to PCF (Policy Control Function) to UPF (User Plane Function)) or the network detects during session setup whether the packets of a flow are encrypted or not.
One or more fields of the FEC header and/or FEC level m header (m=0, 1, 2, . . . , e.g., in the case of ULPFEC) carried in the RTP payload corresponding to the FEC scheme.

Further in Example 2, application provider 102 and/or user equipment 150 may be configured to add at least one or more of the following to the RTP header extension relating to the coding relation for non-MDS FEC schemes:
Information indicating which source PDUs are protected by repair packets. This information may include an identifier sequence number (SN)) of a base source PDU (e.g., PSSN and PSN, or RTP sequence number), and a bit mask for the following source PDUs, where bit n means the nth source PDU following the base source PDU is protected and 0 means not.
The number of columns (L) and the number of rows (D) for two-dimensional (2D) FEC protection:
   If L>0, D=0, indicates row FEC, and no column FEC will follow (1D).

Source packets for each row: SN, SN+1, . . . , SN+(L−1);

If L>0, D=1, indicates row FEC, and column FEC will follow (2D).

Source packets for each row: SN, SN+1, . . . , SN+(L−1)

Source packets for each col: SN, SN+L, . . . , SN+(D−1)*L

After all row FEC packets have been sent, the column FEC packets will be sent.

If L>0, D>1, indicates column FEC of every L packet, D times.

Source packets for each col: SN, SN+L, . . . , SN+(D−1)*L

In FIG. 5, 510 shows an example of such RTP packets.

Some of the above fields may be optional. Session description protocol (SDP) signaling may indicate the presence and absence of optional fields. SDP signaling also maps an RTP HE ID to an RTP HE format.

For option 2 of Example 1, if the source PDUs and the corresponding repair PDUs form respective PDU sets, the following may be added to the RTP extension header:
The PSSN of the source PDU Set, if the source PDU Set and repair PDU Set are in the same flow; or
The PSSN of the source PDU Set and the identifier of the flow to which the source PDU Set belongs. The identifier may be an IP 5-tuple, or a reduced form (e.g., output of a hash function) of the IP 5-tuple.

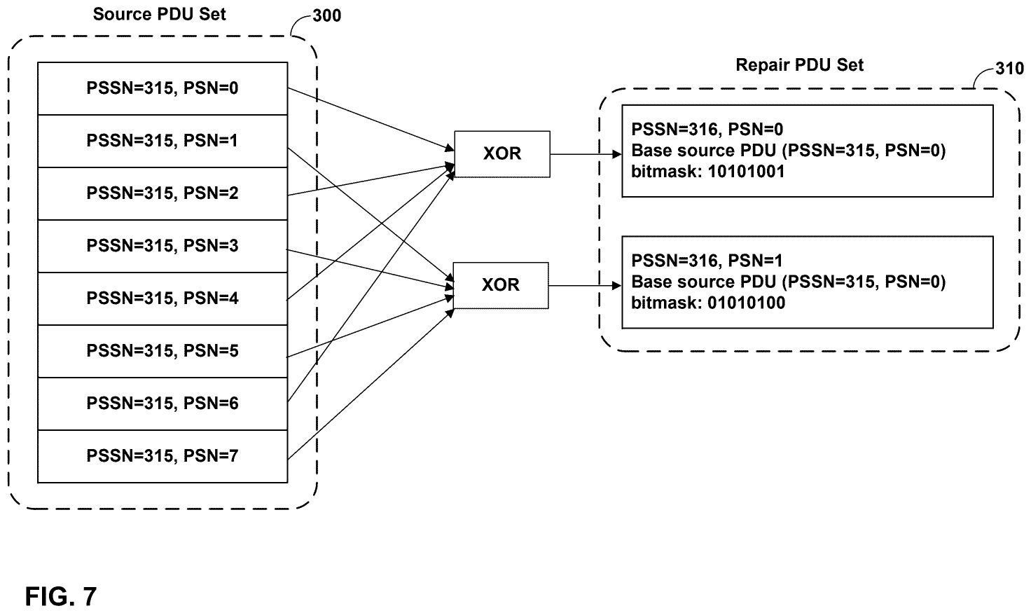

FIG. 7 shows an example bitmask according to one example of the disclosure. The example of FIG. 7 may be used with option 2 of Example 1, where the source PDUs and repair PDUs are in different PDU sets (e.g., a source PDU set and a repair PDU set). In this example, a source PDU set 300 includes eight PDUs all with a PSSN equal to 315. Each PDU of source PDU set 300 may include a unique PSN. A PSN is PDU sequence number of a PDU within a PDU Set. A repair PDU set 310 corresponding to source PDU set 300 includes two repair PDUs. The PDUs in repair PDU set 310 include a different PSSN (e.g., 316) than source PDU set 310. Which repair PDUs correspond to the source PDUs is indicated by a bitmask, as shown in FIG. 7. The values of the bits in the bitmasks may be determined by XOR functions, as shown in FIG. 7.

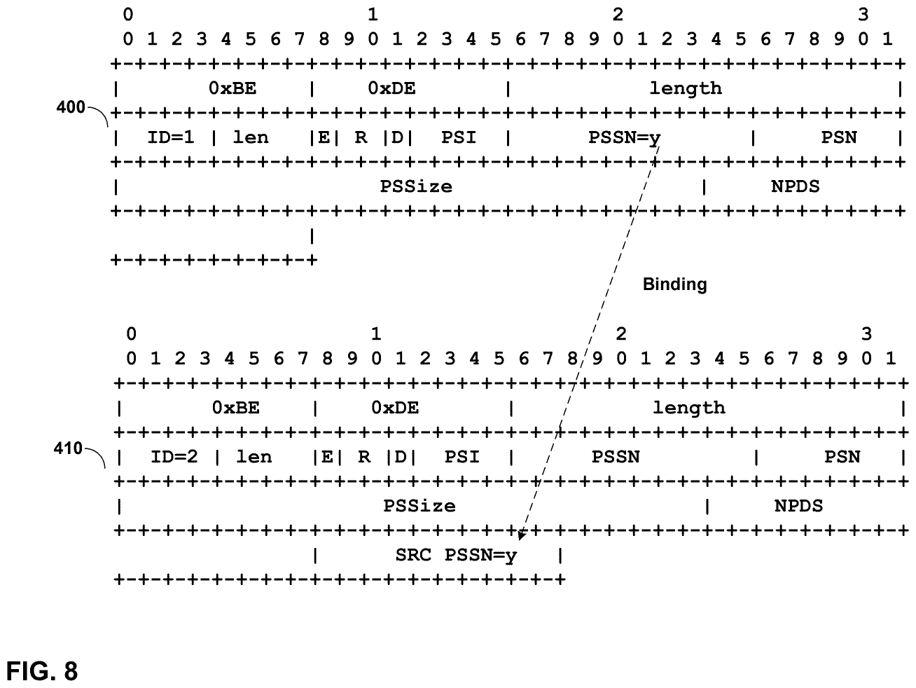

FIG. 8 shows one example of RTP header extensions (e.g., for all FEC schemes). The example of FIG. 8 may be used with option 2 of Example 1, where the source PDUs and repair PDUs are in different PDU sets (e.g., a source PDU set and a repair PDU set). The source PDU set and the repair PDU set are in the same flow in the example of FIG. 8. HE ID=1 means source PDU Set and HE ID=2 means repair PDU Set.

HE 400 shows the HE for PDUs of a source PDU set. HE 410 shows the HE for PDUs of a repair PDU set. The SRC PSSN information in HE 410 identifies the source PDU Set that this repair packet protects (e.g., the repair PDU having HE 410 is bound to the source PDU having HE 400).

The following shows one example of SDP signaling for option 2 of Example 1 described above. The SDP signaling may be included in the SDP Offer and SDP Answer for negotiation between the two endpoints.
For the HE for PDUs of the source PDU set (e.g., same as in current spec), the augmented Backus-Naur form (ABNF) syntax for the extmap attribute may be as follows:
   extensionname=“urn:3gpp:pdu-set-marking:rel-18”
   extensionattributes=*3(format/“pdu-set-size”/“num-pdus-in-pdu-set”)
   format=“short”/“long”
For the HE for PDUs of the repair PDU set, the following syntax element be used:
   extensionname=“urn:3gpp:pdu-set-marking-fec-repair:rel-21”
   extensionattributes=*3(format/“pdu-set-size”/“num-pdus-in-pdu-set”)
   format=“short”/“long”
SDP signaling for the example of FIG. 8 may be as follows:
a=extmap:1 urn:3gpp:pdu-set-marking:rel-18 short pdu-set-size
a=extmap:2 urn:3gpp:pdu-set-marking-fec-repair:rel-21 short pdu-set-size

For other variants of the FEC repair packets, the same or different extmap attribute (extensionname and extensionattributes) ABNF syntax may be used. As an example, the same extmap attribute can be used if the receiver can identify the RTP HE format by the length field (len) in the RTP header extension element.

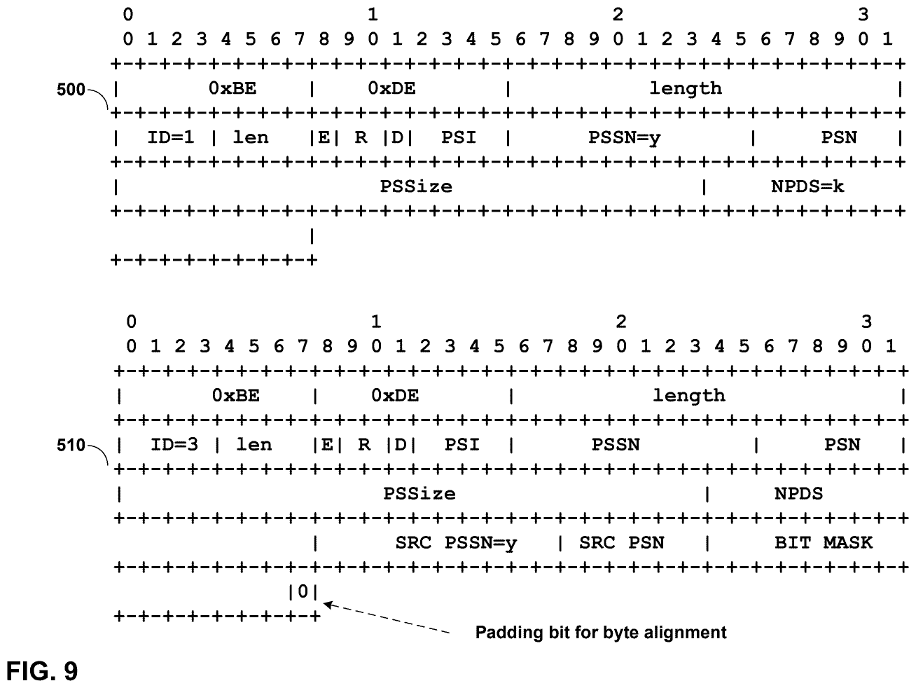

FIG. 9 shows an example of RTP header extensions (e.g., for FlexFEC) where the source PDU set and the repair PDU set are in the same flow. The example of FIG. 9 may be used with option 2 of Example 1, where the source PDUs and repair PDUs are in different PDU sets (e.g., a source PDU set and a repair PDU set). As shown in FIG. 9, HE 500 is an HE for PDUs of a source PDU set. HE 510 is an HE for PDUs of a repair PDU set. SRC PSN identifies the starting PDU of the source PDU set that is protected by this repair packet. BIT MASK is a bit mask of various of various sizes (e.g., 15, 46, 110 as the sizes of the bit mask in RFC 8627). If bit n is set to 1, then the PDU (SRC PSN)+n of the source PDU set is protected; if bit n is set to 0, then the PDU is not protected.

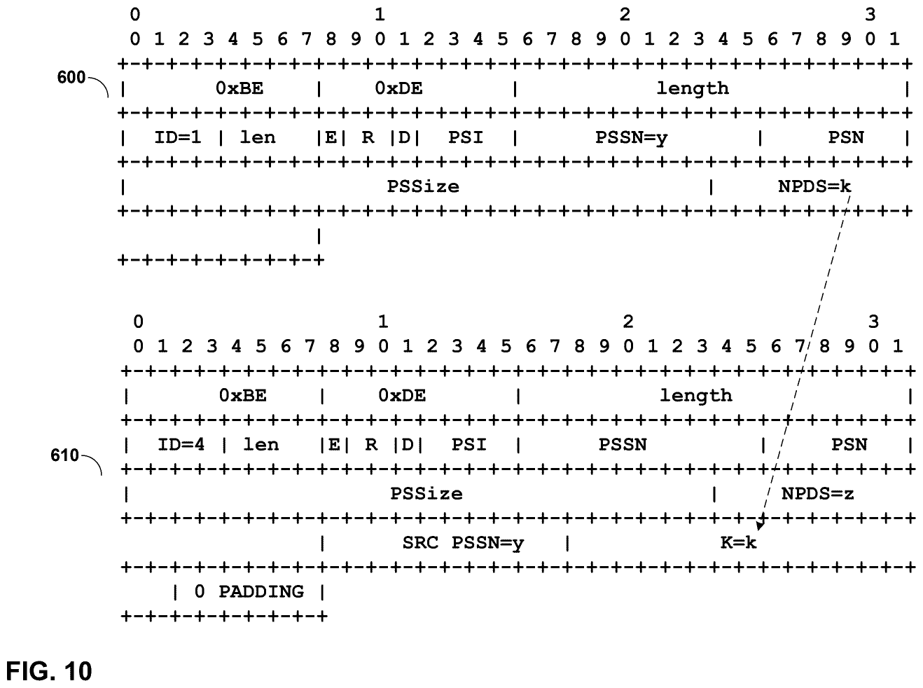

FIG. 10 shows an example of RTP header extensions (e.g., for RS FEC, or RaptorQ FEC) where the source PDU set and the repair PDU set are in the same flow. The example of FIG. 10 may be used with option 2 of Example 1, where the source PDUs and repair PDUs are in different PDU sets (e.g., a source PDU set and a repair PDU set). HE 600 is an HE for PDUs of the source PDU set. HE 610 is an HE for PDUs of a repair PDU set. K is the number of source packets. N may be calculated as the total number of source packets and repair packets, e.g., N=z+K. The field K=k shows the binding between the repair PDUs and the source PDUs, where k is the number of PDUs in a PDU Set (NPDS) of the source PDU Set. The coding rate is K/N.

Note that any of the techniques of Example 2 may be used in combination with any of the techniques of Example 1.

### Example 3: Using Existing Headers for PDU Set Identification

3GPP TR 26.926, clause 5.7.4, describes content delivery modeling for Application layer FEC. There are several FEC schemes defined in the IETF that either permit or require that the RTP source packets are sent unmodified or are sent to be compatible with the payload format they comply to. This restriction, for example, applies to IETF RFC 8627, the Flexible FEC. In a similar fashion, for Raptor FEC in the context of FECFRAME as defined in IETF RFC 6681, for the single sequenced flow in clause 8 of IETF RFC 6681, the source packets are unmodified.

In these cases, the repair packets preferably include sufficient information to form the source block from a sequence of unmodified source packets. For example, IETF RFC 6681 adds to every repair packet the initial sequence number (of the RTP source packet that is included in the source block), the source block length and the encoding symbol ID, summing up to 48 bit in total. FEC encoding ID, encoding symbol size, and maximum source block length are signaled as part of the SDP. The information in the SDP and in the repair packets allows the receiver to add each received source packet to the appropriate encoding symbol ID (ESI) in the source block at the receiver. Once decoded, the information in the source block (the size F), can be used to recover the length of the included packet.

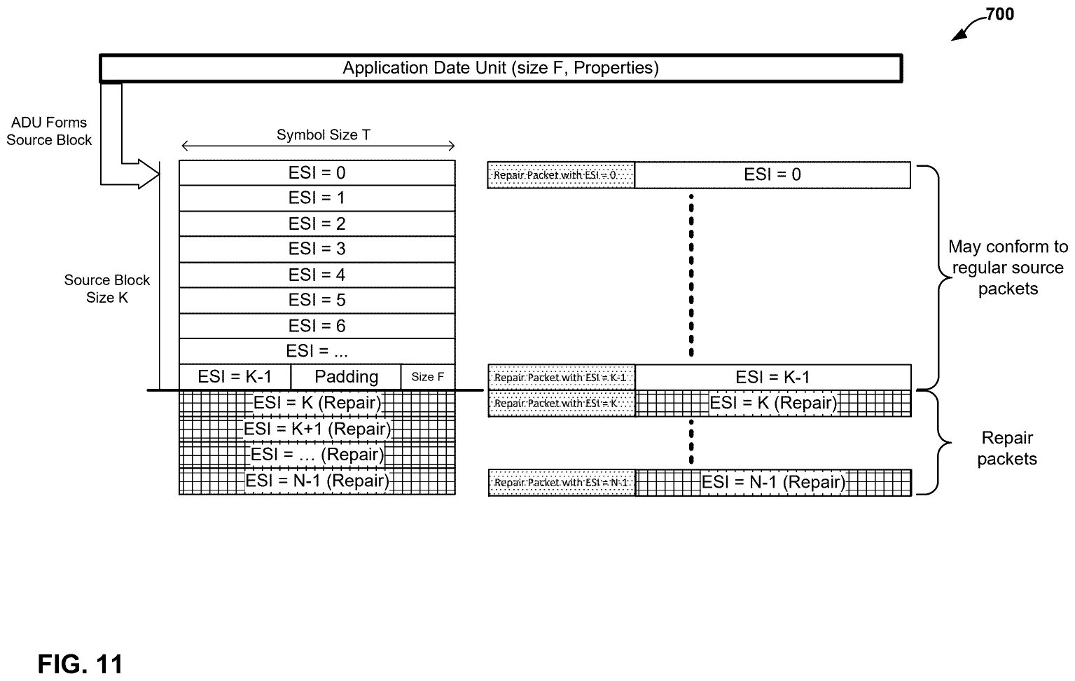

FIG. 11 is an example of packet generation process 700 for application layer FEC.

### Identification of PDU Sets and FEC Data

The following signaling may sent in an SDP:
FEC encoding ID (e.g., what FEC code is used, for example Raptor)
Encoding symbol size (e.g., packet size) and maximum source block length

An entity (e.g. an application Server, a UPF, gnB, etc.) having the above information (e.g., a UE sends the information to the AF, which passed the information to PCF, SMF, and eventually UPF), and also considering the FEC headers, can create virtual PDU sets. Such an entity may perform one or more of the following:
Add actual PDU set headers (e.g., GTP-U packet header to identify a PDU set and/or provide the FEC information). In some examples, this is typically only with delay as source packets arrive before repair packets.
May operate based on virtual PDU sets to for example apply active scheduling of repair packets.

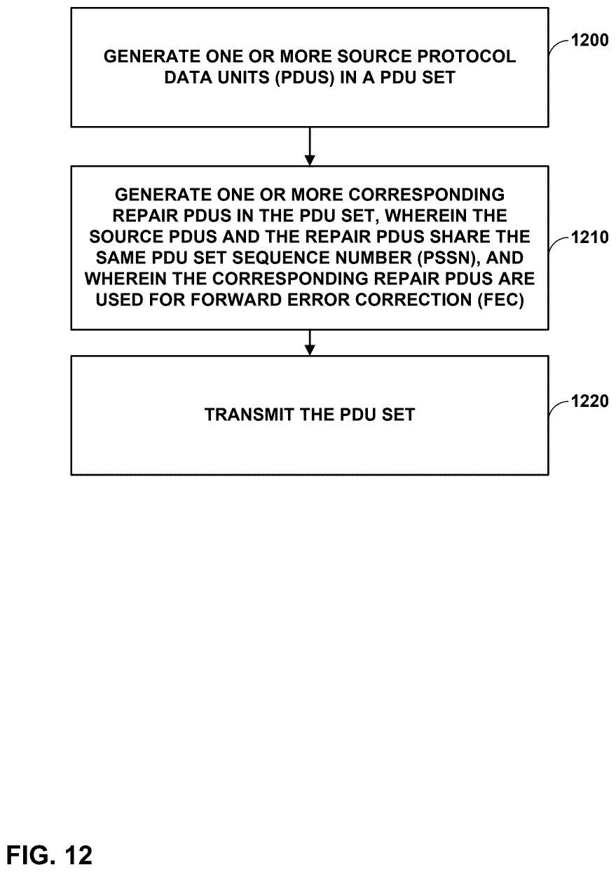

FIG. 12 shows an example process perform by a source device according to the techniques of this disclosure. The source device may be the device transmitting PDU sets and may include a UE, a base station (e.g., a gNB), and/or an application provider, including application provider 102 and/or user equipment 150.

In one example of the disclosure, the source device may be configured to generate one or more source protocol data units (PDUs) in a PDU set (1200), generate one or more corresponding repair PDUs in the PDU set, wherein the source PDUs and the repair PDUs share the same PDU set sequence number (PSSN), and wherein the corresponding repair PDUs are used for forward error correction (FEC) (1210), and transmit the PDU set (1220).

In one example, to generate the one or more source PDUs in the PDU set, the source device is configured to generate a first real-time transport protocol (RTP) header extension (HE) for the one or more source PDUs, the first RTP HE including first information indicating a source PDU type. In addition, to generate the one or more corresponding repair PDUs in the PDU set, the source device is configured to generate a second RTP HE for the one or more corresponding repair PDUs, the second RTP HE including second information indicating a repair PDU type.

In one example, the first information is a first RTP header ID indicating the source PDU type, and the second information is a second RTP header ID indicating the repair PDU type.

In another example, the first information is a first subset of PDU sequence numbers (PSNs) for the one or more source PDUs, and the second information is a second subset of PSNs for the one or more corresponding repair PDUs, wherein the second subset of PSNs is different from the first subset of PSNs.

In another example, the first information is first PDU set importance (PSI) values for the one or more source PDUs, and the second information is second PSI values for the one or more corresponding repair PDUs, wherein the second PSI values are different from the first PSI values.

In another example, the source device is further configured to code a field in the first RTP HE or the second RTP HE that indicates one or more of a redundancy level, whether or not an RTP payload is encrypted, an FEC technique, or a coding relation for a non-MDS (maximum distance separable) FEC technique.

In another example, the source is further configured to generate the first information in a field of the RTP HE for PDU set marking, and generate the second information in the field of the RTP HE for PDU set marking.

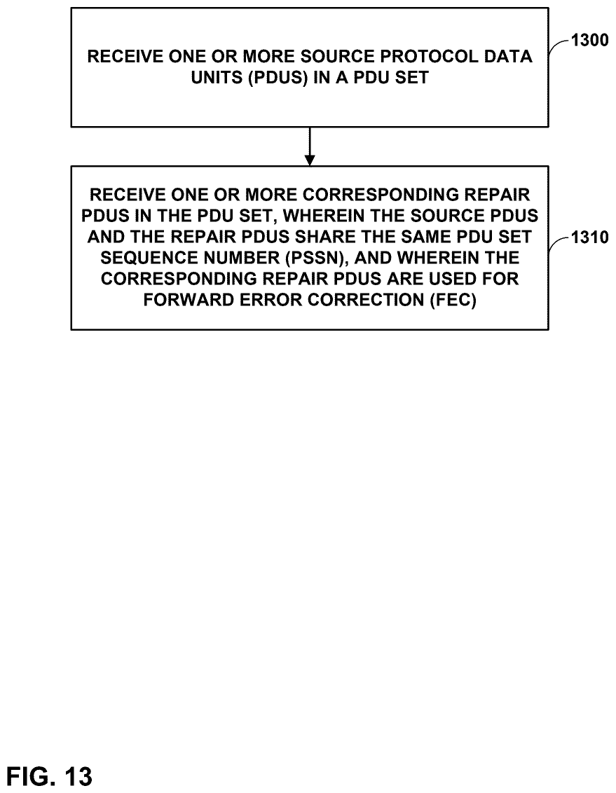

FIG. 13 shows an example process perform by client device according to the techniques of this disclosure. The client device may be the device receiving PDU sets and include a UE, a base station (e.g., a gNB), and/or an application provider, including application provider 102 and/or user equipment 150.

In one example, the client device may be configured to receive one or more source protocol data units (PDUs) in a PDU set (1300), and receive one or more corresponding repair PDUs in the PDU set, wherein the source PDUs and the repair PDUs share the same PDU set sequence number (PSSN), and wherein the corresponding repair PDUs are used for forward error correction (FEC) (1310).

In one example, to receive the one or more source PDUs in the PDU set, the client device is configured to receive a first real-time transport protocol (RTP) header extension (HE) for the one or more source PDUs, the first RTP HE including first information indicating a source PDU type. In addition, to receive the one or more corresponding repair PDUs in the PDU set, the client device is configured to receive a second RTP HE for the one or more corresponding repair PDUs, the second RTP HE including second information indicating a repair PDU type.

In one example, the first information is a first RTP header ID indicating the source PDU type, and wherein the second information is a second RTP header ID indicating the repair PDU type.

In another example, the first information is a first subset of PDU sequence numbers (PSNs) for the one or more source PDUs, and wherein the second information is a second subset of PSNs for the one or more corresponding repair PDUs, wherein the second subset of PSNs is different from the first subset of PSNs.

In another example, the first information is first PDU set importance (PSI) values for the one or more source PDUs, and wherein the second information is second PSI values for the one or more corresponding repair PDUs, wherein the second PSI values are different from the first PSI values.

In another example, the client device is further configured to decode a field in the first RTP HE or the second RTP HE that indicates one or more of a redundancy level, whether or not an RTP payload is encrypted, an FEC technique, or a coding relation for a non-MDS (maximum distance separable) FEC technique.

In another example, the client device is further configured to decode the first information in a field of the RTP HE for PDU set marking, and decode the second information in the field of the RTP HE for PDU set marking.

In another example, the client device is further configured to perform FEC on the one or more source PDUs using the one or more corresponding repair PDUs.

Aspects of the disclosure may include any combination of the following:

Aspect 1A. A method of retrieving media data, the method comprising: transmitting one or more source protocol data units (PDUs) in a PDU set; and transmitting one or more corresponding repair PDUs in the PDU set, wherein the source PDUs and the repair PDUs share the same PDU set sequence number (PSSN), and wherein the corresponding repair PDUs are used for forward error correction (FEC).

Aspect 2A. The method of Aspect 1A, wherein the one or more source PDUs represent data for a video frame.

Aspect 3A. A method of retrieving media data, the method comprising: transmitting one or more source protocol data units (PDUs) in a first PDU set; and transmitting one or more corresponding repair PDUs in a second PDU set, wherein a real-time transport protocol (RTP) RTP header extension in the second PDU set identifies corresponding source PDUs of the one or more source PDUs in the first PDU set, and wherein the corresponding repair PDUs are used for forward error correction (FEC).

Aspect 4A. A method of retrieving media data, the method comprising: transmitting one or more source protocol data units (PDUs) in a first PDU set, wherein a real-time transport protocol (RTP) RTP header extension in the first PDU set includes information that identifies the first PDU set as include source PDUs; and transmitting one or more corresponding repair PDUs in a second PDU set, wherein the real-time transport protocol (RTP) RTP header extension in the second PDU set includes information that identifies the second PDU set as including repair PDUs, and wherein the corresponding repair PDUs are used for forward error correction (FEC).

Aspect 5A. The method of Aspect 4A, wherein the information is an RTP head extension ID that is different for the source PDUs and the repair PDUs.

Aspect 6A. The method of Aspect 4A, wherein the information is a subset of a PDU sequence number space.

Aspect 7A. The method of Aspect 4A, wherein the information is a PSI value.

Aspect 8A. The method of Aspect 4A, wherein the information is contained in a separate field of the RTP header extension.

Aspect 9A. The method of Aspect 4A, further comprising: coding a field in the RTP header extension to indicate a redundancy level.

Aspect 10A. The method of Aspect 4A, further comprising: coding a field in the RTP header extension to indicate whether or not an RTP payload is encrypted.

Aspect 11A. The method of Aspect 4A, further comprising: coding a field in a forward error correction (FEC) header that indicates an FEC technique.

Aspect 12A. The method of Aspect 4A, further comprising: coding, in the RTP header extension, and indication of a coding relation for a non-MDS (maximum distance separable) FEC technique.

Aspect 13A. An apparatus for retrieving media data, the device comprising: a memory; and one or more processors in communication with the memory, the one or more processors configured to perform any combination of the methods of Aspects 1-12.

Aspect 14A. The apparatus of Aspect 13A, wherein the apparatus is a user equipment (UE) or an application provider.

Aspect 15A. The apparatus of Aspect 13A, wherein the apparatus comprises at least one of: an integrated circuit; a microprocessor; and a wireless communication device.

Aspect 16A. A method of receiving media data, the method comprising: receiving one or more source protocol data units (PDUs) of a PDU set, the one or more source PDUs having a PDU set sequence number (PSSN); receiving one or more repair PDUs having the PSSN; determining that the one or more repair PDUs correspond to the one or more source PDUs when the PSSN of the repair PDUs matches the PSSN of the source PDUs; and performing forward error correction (FEC) using the source PDUs and the repair PDUs.

Aspect 17A. A method of receiving media data, the method comprising: receiving one or more source protocol data units (PDUs) in a first PDU set; receiving one or more corresponding repair PDUs in a second PDU set, wherein a real-time transport protocol (RTP) RTP header extension in the second PDU set identifies corresponding source PDUs of the one or more source PDUs in the first PDU; and performing forward error correction (FEC) using the repair PDUs and the corresponding source PDUs.

Aspect 18A. A method of receiving media data, the method comprising: receiving one or more source protocol data units (PDUs) in a first PDU set, wherein a real-time transport protocol (RTP) RTP header extension in the first PDU set includes information that identifies the first PDU set as including source PDUs; receiving one or more corresponding repair PDUs in a second PDU set, wherein a real-time transport protocol (RTP) RTP header extension in the second PDU set includes information that identifies the second PDU set as including repair PDUs corresponding to the source PDUs of the first PDU set; and performing forward error correction (FEC) using the source PDUs and the repair PDUs corresponding to the source PDUs.

Aspect 19A. A method of receiving media data, the method comprising: receiving one or more source protocol data units (PDUs); receiving one or more repair PDUs, the one or more repair PDUs including an FEC header; receiving session description protocol (SDP) signaling that includes one or more of a forward error correction (FEC) encoding ID, encoding symbol size, or maximum source block length in session description protocol (SDP); and creating a virtual PDU set of source PDUs and corresponding repair PDUs based on the SDP signaling the FEC header.

Aspect 1B. A method of transmitting data, the method comprising: generating one or more source protocol data units (PDUs) in a PDU set; generating one or more corresponding repair PDUs in the PDU set, wherein the source PDUs and the repair PDUs share the same PDU set sequence number (PSSN), and wherein the corresponding repair PDUs are used for forward error correction (FEC); and transmitting the PDU set.

Aspect 2B. The method of Aspect 1B, wherein generating the one or more source PDUs in the PDU set includes generating a first real-time transport protocol (RTP) header extension (HE) for the one or more source PDUs, the first RTP HE including first information indicating a source PDU type, and wherein generating the one or more corresponding repair PDUs in the PDU set includes generating a second RTP HE for the one or more corresponding repair PDUs, the second RTP HE including second information indicating a repair PDU type.

Aspect 3B. The method of Aspect 2B, wherein the first information is a first RTP header ID indicating the source PDU type, and wherein the second information is a second RTP header ID indicating the repair PDU type.

Aspect 4B. The method of Aspect 2B, wherein the first information is a first subset of PDU sequence numbers (PSNs) for the one or more source PDUs, and wherein the second information is a second subset of PSNs for the one or more corresponding repair PDUs, wherein the second subset of PSNs is different from the first subset of PSNs.

Aspect 5B. The method of Aspect 2B, wherein the first information is first PDU set importance (PSI) values for the one or more source PDUs, and wherein the second information is second PSI values for the one or more corresponding repair PDUs, wherein the second PSI values are different from the first PSI values.

Aspect 6B. The method of Aspect 2B, further comprising: coding a field in the first RTP HE or the second RTP HE that indicates one or more of a redundancy level, whether or not an RTP payload is encrypted, an FEC technique, or a coding relation for a non-MDS (maximum distance separable) FEC technique.

Aspect 7B. The method of Aspect 2B, further comprising: generating the first information in a field of the RTP HE for PDU set marking; and generating the second information in the field of the RTP HE for PDU set marking.

Aspect 8B. An apparatus configured to transmit data, the apparatus comprising: a memory; and processing circuitry connected to the memory, the processing circuitry configured to: generate one or more source protocol data units (PDUs) in a PDU set; generate one or more corresponding repair PDUs in the PDU set, wherein the source PDUs and the repair PDUs share the same PDU set sequence number (PSSN), and wherein the corresponding repair PDUs are used for forward error correction (FEC); and transmit the PDU set.

Aspect 9B. The apparatus of Aspect 8B, wherein to generate the one or more source PDUs in the PDU set, the processing circuitry is configured to generate a first real-time transport protocol (RTP) header extension (HE) for the one or more source PDUs, the first RTP HE including first information indicating a source PDU type, and wherein to generate the one or more corresponding repair PDUs in the PDU set, the processing circuitry is configured to generate a second RTP HE for the one or more corresponding repair PDUs, the second RTP HE including second information indicating a repair PDU type.

Aspect 10B. The apparatus of Aspect 9B, wherein the first information is a first RTP header ID indicating the source PDU type, and wherein the second information is a second RTP header ID indicating the repair PDU type.

Aspect 11B. The apparatus of Aspect 9B, wherein the first information is a first subset of PDU sequence numbers (PSNs) for the one or more source PDUs, and wherein the second information is a second subset of PSNs for the one or more corresponding repair PDUs, wherein the second subset of PSNs is different from the first subset of PSNs.

Aspect 12B. The apparatus of Aspect 9B, wherein the first information is first PDU set importance (PSI) values for the one or more source PDUs, and wherein the second information is second PSI values for the one or more corresponding repair PDUs, wherein the second PSI values are different from the first PSI values.

Aspect 13B. The apparatus of Aspect 9B, wherein the processing circuitry is further configured to: code a field in the first RTP HE or the second RTP HE that indicates one or more of a redundancy level, whether or not an RTP payload is encrypted, an FEC technique, or a coding relation for a non-MDS (maximum distance separable) FEC technique.

Aspect 14B. The apparatus of Aspect 9B, wherein the processing circuitry is further configured to: generate the first information in a field of the RTP HE for PDU set marking; and generate the second information in the field of the RTP HE for PDU set marking.

Aspect 15B. A method of receiving data, the method comprising: receiving one or more source protocol data units (PDUs) in a PDU set; and receiving one or more corresponding repair PDUs in the PDU set, wherein the source PDUs and the repair PDUs share the same PDU set sequence number (PSSN), and wherein the corresponding repair PDUs are used for forward error correction (FEC).

Aspect 16B. The method of Aspect 15B, wherein receiving the one or more source PDUs in the PDU set includes receiving a first real-time transport protocol (RTP) header extension (HE) for the one or more source PDUs, the first RTP HE including first information indicating a source PDU type, and wherein receiving the one or more corresponding repair PDUs in the PDU set includes receiving a second RTP HE for the one or more corresponding repair PDUs, the second RTP HE including second information indicating a repair PDU type.

Aspect 17B. The method of Aspect 16B, wherein the first information is a first RTP header ID indicating the source PDU type, and wherein the second information is a second RTP header ID indicating the repair PDU type.

Aspect 18B. The method of Aspect 16B, wherein the first information is a first subset of PDU sequence numbers (PSNs) for the one or more source PDUs, and wherein the second information is a second subset of PSNs for the one or more corresponding repair PDUs, wherein the second subset of PSNs is different from the first subset of PSNs.

Aspect 19B. The method of Aspect 16B, wherein the first information is first PDU set importance (PSI) values for the one or more source PDUs, and wherein the second information is second PSI values for the one or more corresponding repair PDUs, wherein the second PSI values are different from the first PSI values.

Aspect 20B. The method of Aspect 16B, further comprising: decoding a field in the first RTP HE or the second RTP HE that indicates one or more of a redundancy level, whether or not an RTP payload is encrypted, an FEC technique, or a coding relation for a non-MDS (maximum distance separable) FEC technique.

Aspect 21B. The method of Aspect 16B, further comprising: decoding the first information in a field of the RTP HE for PDU set marking; and decoding the second information in the field of the RTP HE for PDU set marking.

Aspect 22B. The method of Aspect 15B, further comprising: performing FEC on the one or more source PDUs using the one or more corresponding repair PDUs.

Aspect 23B. An apparatus configured to receive data, the apparatus comprising: a memory; and processing circuitry connected to the memory, the processing circuitry configured to: receive one or more source protocol data units (PDUs) in a PDU set; and receive one or more corresponding repair PDUs in the PDU set, wherein the source PDUs and the repair PDUs share the same PDU set sequence number (PSSN), and wherein the corresponding repair PDUs are used for forward error correction (FEC).

Aspect 24B. The apparatus of Aspect 23B, wherein to receive the one or more source PDUs in the PDU set, the processing circuitry is configured to receive a first real-time transport protocol (RTP) header extension (HE) for the one or more source PDUs, the first RTP HE including first information indicating a source PDU type, and wherein to receive the one or more corresponding repair PDUs in the PDU set, the processing circuitry is configured to receive a second RTP HE for the one or more corresponding repair PDUs, the second RTP HE including second information indicating a repair PDU type.

Aspect 25B. The apparatus of Aspect 24B, wherein the first information is a first RTP header ID indicating the source PDU type, and wherein the second information is a second RTP header ID indicating the repair PDU type.

Aspect 26B. The apparatus of Aspect 24B, wherein the first information is a first subset of PDU sequence numbers (PSNs) for the one or more source PDUs, and wherein the second information is a second subset of PSNs for the one or more corresponding repair PDUs, wherein the second subset of PSNs is different from the first subset of PSNs.

Aspect 27B. The apparatus of Aspect 24B, wherein the first information is first PDU set importance (PSI) values for the one or more source PDUs, and wherein the second information is second PSI values for the one or more corresponding repair PDUs, wherein the second PSI values are different from the first PSI values.

Aspect 28B. The apparatus of Aspect 24B, wherein the processing circuitry is further configured to: decode a field in the first RTP HE or the second RTP HE that indicates one or more of a redundancy level, whether or not an RTP payload is encrypted, an FEC technique, or a coding relation for a non-MDS (maximum distance separable) FEC technique.

Aspect 29B. The apparatus of Aspect 24B, wherein the processing circuitry is further configured to: decode the first information in a field of the RTP HE for PDU set marking; and decode the second information in the field of the RTP HE for PDU set marking.

Aspect 30B. The apparatus of Aspect 23B, wherein the processing circuitry is further configured to: perform FEC on the one or more source PDUs using the one or more corresponding repair PDUs.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of transmitting data, the method comprising:
generating one or more source protocol data units (PDUs) in a PDU set;
generating one or more corresponding repair PDUs in the PDU set, wherein the source PDUs and the repair PDUs share the same PDU set sequence number (PSSN), and wherein the corresponding repair PDUs are used for forward error correction (FEC); and
transmitting the PDU set.

2. The method of claim 1, wherein generating the one or more source PDUs in the PDU set includes generating a first real-time transport protocol (RTP) header extension (HE) for the one or more source PDUs, the first RTP HE including first information indicating a source PDU type, and
wherein generating the one or more corresponding repair PDUs in the PDU set includes generating a second RTP HE for the one or more corresponding repair PDUs, the second RTP HE including second information indicating a repair PDU type.

3. The method of claim 2, wherein the first information is a first RTP header ID indicating the source PDU type, and wherein the second information is a second RTP header ID indicating the repair PDU type.

4. The method of claim 2, wherein the first information is a first subset of PDU sequence numbers (PSNs) for the one or more source PDUs, and wherein the second information is a second subset of PSNs for the one or more corresponding repair PDUs, wherein the second subset of PSNs is different from the first subset of PSNs.

5. The method of claim 2, wherein the first information is first PDU set importance (PSI) values for the one or more source PDUs, and wherein the second information is second PSI values for the one or more corresponding repair PDUs, wherein the second PSI values are different from the first PSI values.

6. The method of claim 2, further comprising:
coding a field in the first RTP HE or the second RTP HE that indicates one or more of a redundancy level, whether or not an RTP payload is encrypted, an FEC technique, or a coding relation for a non-MDS (maximum distance separable) FEC technique.

7. The method of claim 2, further comprising:
generating the first information in a field of the RTP HE for PDU set marking; and
generating the second information in the field of the RTP HE for PDU set marking.

8. An apparatus configured to transmit data, the apparatus comprising:
a memory; and
processing circuitry connected to the memory, the processing circuitry configured to:
generate one or more source protocol data units (PDUs) in a PDU set;
generate one or more corresponding repair PDUs in the PDU set, wherein the source PDUs and the repair PDUs share the same PDU set sequence number (PSSN), and wherein the corresponding repair PDUs are used for forward error correction (FEC); and
transmit the PDU set.

9. The apparatus of claim 8, wherein to generate the one or more source PDUs in the PDU set, the processing circuitry is configured to generate a first real-time transport protocol (RTP) header extension (HE) for the one or more source PDUs, the first RTP HE including first information indicating a source PDU type, and
wherein to generate the one or more corresponding repair PDUs in the PDU set, the processing circuitry is configured to generate a second RTP HE for the one or more corresponding repair PDUs, the second RTP HE including second information indicating a repair PDU type.

10. The apparatus of claim 9, wherein the first information is a first RTP header ID indicating the source PDU type, and wherein the second information is a second RTP header ID indicating the repair PDU type.

11. The apparatus of claim 9, wherein the first information is a first subset of PDU sequence numbers (PSNs) for the one or more source PDUs, and wherein the second information is a second subset of PSNs for the one or more corresponding repair PDUs, wherein the second subset of PSNs is different from the first subset of PSNs.

12. The apparatus of claim 9, wherein the first information is first PDU set importance (PSI) values for the one or more source PDUs, and wherein the second information is second PSI values for the one or more corresponding repair PDUs, wherein the second PSI values are different from the first PSI values.

13. The apparatus of claim 9, wherein the processing circuitry is further configured to:
code a field in the first RTP HE or the second RTP HE that indicates one or more of a redundancy level, whether or not an RTP payload is encrypted, an FEC technique, or a coding relation for a non-MDS (maximum distance separable) FEC technique.

14. The apparatus of claim 9, wherein the processing circuitry is further configured to:
generate the first information in a field of the RTP HE for PDU set marking; and
generate the second information in the field of the RTP HE for PDU set marking.

15. An apparatus configured to receive data, the apparatus comprising:
a memory; and
processing circuitry connected to the memory, the processing circuitry configured to:
receive one or more source protocol data units (PDUs) in a PDU set; and
receive one or more corresponding repair PDUs in the PDU set, wherein the source PDUs and the repair PDUs share the same PDU set sequence number (PSSN), and wherein the corresponding repair PDUs are used for forward error correction (FEC).

16. The apparatus of claim 15, wherein to receive the one or more source PDUs in the PDU set, the processing circuitry is configured to receive a first real-time transport protocol (RTP) header extension (HE) for the one or more source PDUs, the first RTP HE including first information indicating a source PDU type, and
wherein to receive the one or more corresponding repair PDUs in the PDU set, the processing circuitry is configured to receive a second RTP HE for the one or more corresponding repair PDUs, the second RTP HE including second information indicating a repair PDU type.

17. The apparatus of claim 16, wherein the first information is a first RTP header ID indicating the source PDU type, and wherein the second information is a second RTP header ID indicating the repair PDU type.

18. The apparatus of claim 16, wherein the first information is a first subset of PDU sequence numbers (PSNs) for the one or more source PDUs, and wherein the second information is a second subset of PSNs for the one or more corresponding repair PDUs, wherein the second subset of PSNs is different from the first subset of PSNs.

19. The apparatus of claim 16, wherein the first information is first PDU set importance (PSI) values for the one or more source PDUs, and wherein the second information is second PSI values for the one or more corresponding repair PDUs, wherein the second PSI values are different from the first PSI values.

20. The apparatus of claim 16, wherein the processing circuitry is further configured to:
decode a field in the first RTP HE or the second RTP HE that indicates one or more of a redundancy level, whether or not an RTP payload is encrypted, an FEC technique, or a coding relation for a non-MDS (maximum distance separable) FEC technique.
